(19) United States
(12) Patent Application Publication
(10) Pub. No.: US 2026/0131676 A1
(43) Pub. Date: May 14, 2026

(54) VEHICLE

(71) Applicant: TOYOTA JIDOSHA KABUSHIKI KAISHA, Toyota-shi (JP)

(72) Inventors: Yuya AOKI, Myoshi-shi (JP); Toru ANDO, Obu-shi (JP); Akitomo SHIRAI, Toyokawa-shi (JP)

(73) Assignee: TOYOTA JIDOSHA KABUSHIKI KAISHA, Toyota-shi (JP)

(21) Appl. No.: 19/265,322

(22) Filed: Jul. 10, 2025

(30) Foreign Application Priority Data
Nov. 12, 2024 (JP) 2024-197569

(51) Int. Cl. B60L 53/16

(52) U.S. Cl. CPC B60L 53/16

(57) ABSTRACT

When a charging connector is connected to an inlet, a charging control ECU puts the charging connector in a locked state by a lock device. When a lock release mechanism is operated and the lock device is in an unlocked state, the charging control ECU sets a flag to 1. The charging control ECU outputs a lock command and then outputs an unlock command when the flag is set to 1 in a failure detection process. When the lock device is in the unlocked state, no failure is diagnosed, and when the lock device is not in the unlocked state, an unlock failure is diagnosed.

### CROSS-REFERENCE TO RELATED APPLICATION

This application claims priority to Japanese Patent Application No. 2024-197569 filed on Nov. 12, 2024. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

Japanese Unexamined Patent Application Publication No. 2021-150980 (JP 2021-150980 A) discloses a vehicle charging device that determines a failure of a lock actuator for locking a power supply side connector (charging connector) connected to a charging port (inlet) of a vehicle. A control device for charging according to JP 2021-150980 A is configured to perform an operation check of the lock actuator when a vehicle speed is equal to or higher than a predetermined speed. In the operation check, an operation command to a lock pin is transmitted to the lock actuator, and the failure of the lock actuator is determined based on whether a position of the lock pin detected by a position detection sensor is at a position specified by the operation command.

### SUMMARY

In JP 2021-150980 A, the control device outputs a lock command and an unlock command to the lock actuator. Then, the failure of the lock actuator is determined based on the position of the lock pin after the lock command and after the unlock command. Therefore, when the unlock command is not output due to some kind of abnormality, an unlock failure of the lock actuator cannot be determined.

An object of the present disclosure is to enable a diagnosis of an unlock failure even when an unlock command is not output.

A vehicle of the present disclosure includes
an inlet to which a charging connector is connectable,
a lock device configured to switch between a locked state in which the charging connector is not removable from the inlet and an unlocked state in which the charging connector is removable from the inlet, and
a control device.

The lock device includes an actuator and a lock release mechanism.

The actuator is configured to operate such that the unlocked state is switched to the locked state in response to a lock command from the control device, and the locked state is switched to the unlocked state in response to an unlock command from the control device.

The lock release mechanism is configured to switch the locked state to the unlocked state regardless of the operation of the actuator.

The control device is configured to,
when detection is made that the lock release mechanism is operated and the locked state is switched to the unlocked state,
output the lock command and then output the unlock command in a state where the charging connector is removed from the inlet, and
diagnose an unlock failure when the lock device is not in the unlocked state after the unlock command is output.

With the configuration, the actuator receives the lock command from the control device and switches the lock device from the unlocked state to the locked state. The actuator receives the unlock command from the control device and switches the lock device from the locked state to the unlocked state. When the lock release mechanism is operated, the lock device is switched from the locked state to the unlocked state regardless of the operation of the actuator. The control device is configured to, when the detection is made that the locked state is switched to the unlocked state by the lock release mechanism, output the lock command and then output the unlock command in a state where the charging connector is removed from the inlet. The control device is configured to diagnose the unlock failure when the lock device is not in the unlocked state after the unlock command is output.

The switching from the locked state to the unlocked state by the lock release mechanism is highly likely to be performed when the unlock command is not output from the control device and the unlocked state is not achieved. Alternatively, the switching from the locked state to the unlocked state by the lock release mechanism is highly likely to be performed when the actuator does not operate from the locked state to the unlocked state and the unlocked state is not achieved. When the detection is made that the lock release mechanism is operated and the locked state is switched to the unlocked state, the control device is configured to output the lock command and then output the unlock command in a state where the charging connector is removed from the inlet. When the lock device is not in the unlocked state after the unlock command, the lock device is in the locked state. Therefore, a failure in which the unlock command is not output from the control device or a failure in which the actuator does not operate from the locked state to the unlocked state can be diagnosed. Therefore, the unlock failure can be diagnosed even when the unlock command is not output.

The lock device may include a lock pin driven by the actuator, and the control device may be configured to detect the locked state and the unlocked state based on a position of the lock pin.

With the configuration, the locked state and the unlocked state can be relatively easily detected by detecting the position of the lock pin.

The control device may be configured to detect that the locked state is switched to the unlocked state by the operation of the lock release mechanism when the position of the lock pin is changed from the locked state to the unlocked state in a state where the unlock command is not output.

When the lock release mechanism is operated and the locked state is switched to the unlocked state, the position of the lock pin is switched from the locked state to the unlocked state even though the control device does not output the unlock command. With the configuration, the control device can detect that the locked state is switched to the unlocked state by the operation of the lock release mechanism.

The control device may be configured to diagnose the unlock failure while the vehicle is traveling.

When the vehicle is traveling, the charging connector is removed from the inlet. With the configuration, the unlock failure can be diagnosed more reliably in a state where the charging connector is removed from the inlet.

The control device may be configured to issue an alert when the unlock failure is diagnosed.

With the configuration, a user can know that the unlock failure occurs.

According to the present disclosure, the unlock failure can be diagnosed even when the unlock command is not output.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle according to the present embodiment;

FIG. 2 is a diagram illustrating an example of an appearance of a charging connector;

FIG. 3 is a diagram illustrating a schematic configuration of a lock device;

FIG. 4 is a flowchart showing an example of a temporary abnormality detection process executed by a charging control ECU; and

FIG. 5 is a flowchart showing an example of a failure detection process executed by the charging control ECU.

### DETAILED DESCRIPTION OF EMBODIMENTS

An embodiment of the present disclosure will be described in detail with reference to the drawings. In the drawings, the same or similar parts are denoted by the same signs, and description thereof will not be repeated.

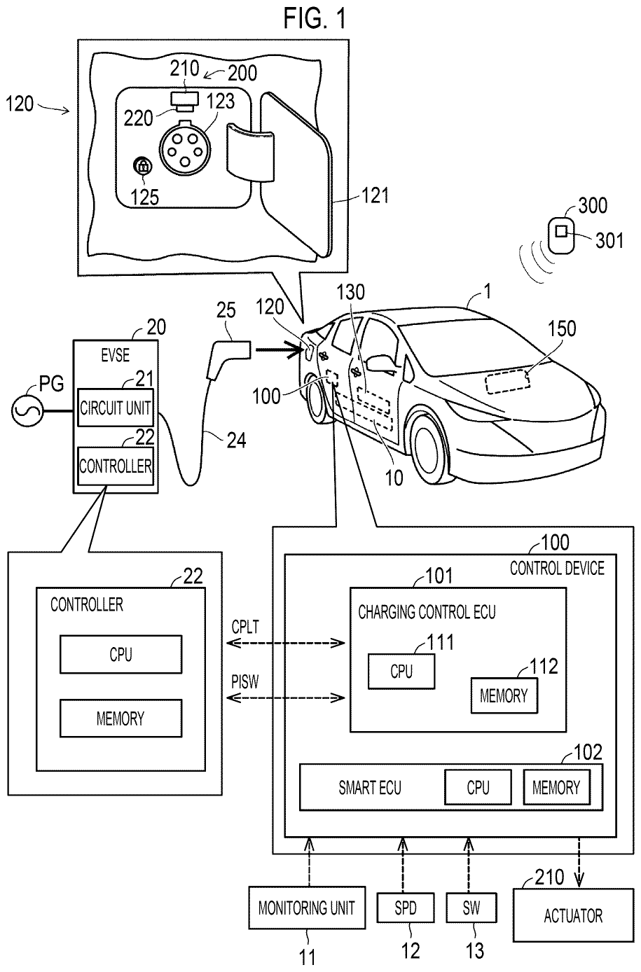

FIG. 1 is a diagram illustrating a schematic configuration of a vehicle 1 according to the present embodiment. The vehicle 1 includes a battery 10, a control device 100, an inlet 120, a charging circuit 130, and a human machine interface (HMI) device 150. The vehicle 1 is an electrified vehicle (xEV) configured to be able to travel using electric power stored in the battery 10. For example, the vehicle 1 may be a battery electric vehicle (BEV). The battery 10 is a known secondary battery for a vehicle, and may be, for example, a lithium ion battery.

The inlet 120 includes a charging lid 121 and a charging port 123. The charging lid 121 is configured to be opened and closed by a user, and in a closed state, cover the charging port 123, and in an open state, expose the charging port 123. When the battery 10 is charged, the charging connector 25 is connected to the charging port 123 in a state where the charging lid 121 is opened. The charging circuit 130 charges the battery 10 using electric power supplied from the outside of the vehicle to the charging port 123.

The control device 100 includes a charging control ECU 101 and a smart ECU 102. The charging control ECU 101 includes a central processing unit (CPU) 111 and a memory 112. The smart ECU 102 also includes a CPU and a memory in the same manner.

Electric vehicle supply equipment (EVSE) 20 charges the battery 10 with electric power supplied from an external power source PG (for example, an electric power system). The EVSE 20 includes a circuit unit 21 and a controller 22. The EVSE 20 further includes a charging cable 24 that extends from a main body of the EVSE 20 to the outside. The controller 22 includes a CPU and a memory, and controls the circuit unit 21. The circuit unit 21 includes, for example, a power conversion circuit and a circuit that charges the battery 10 with electric power supplied from the external power source PG. The charging connector (plug) 25 attachable to and detachable from the charging port 123 of the inlet 120 is provided at a tip of the charging cable 24. Charging from the EVSE 20 to the vehicle 1 (battery 10) is possible by connecting the charging connector 25 to the inlet 120 (charging port 123) of the vehicle 1.

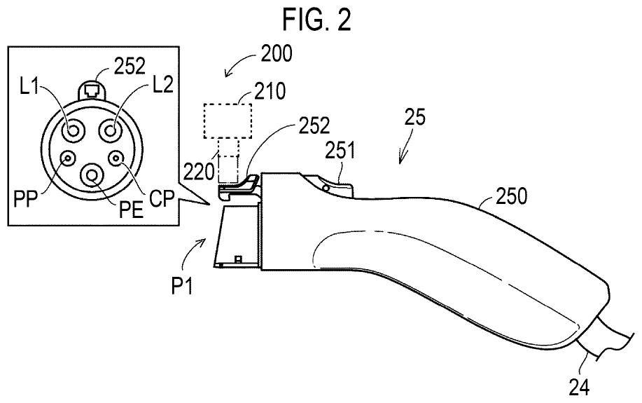

FIG. 2 is a diagram illustrating an example of an appearance of the charging connector 25. The charging connector 25 is provided with a connector terminal on an end surface P1 of a main body part 250, and the end surface P1 is connected to the charging port 123 of the inlet 120. The end surface P1 has the connector terminal. The connector terminal provided in the end surface P1 includes a terminal L1, a terminal L2, a terminal PE, a terminal PP, and a terminal CP. An inlet terminal is provided in the charging port 123 of the inlet 120, similar to the connector terminal provided on the end surface P1. The terminals L1, L2 are terminals to which electric power is supplied. For example, in a case of alternating current (AC) power, the terminals L1, L2 may be a hot terminal or a cold terminal. In a case of direct current (DC) power, the terminals L1, L2 may be a positive terminal or a negative terminal. The terminal PE is a ground (GND) terminal.

The terminal PP is a terminal (hereinafter, also referred to as “PISW”) for detecting (proximity detection) a state (connected state/mated state/unmated state) between the charging connector 25 and the inlet 120. Hereinafter, the state between the charging connector 25 and the inlet 120 is also referred to as a “connector state”. The terminal PP outputs a voltage signal (PISW signal) indicating the connector state to the vehicle 1 side. The terminal CP corresponds to a terminal (hereinafter, also referred to as “CPLT”) for a CPLT signal defined in, for example, a standard “IEC/TS 62763:2013”. The CPLT signal is a pulse width modulation (PWM) signal used for communication between the vehicle 1 and the EVSE 20.

The charging connector 25 further includes a latch release button 251 and a latch 252. The latch release button 251 releases a latch of the charging connector 25 to the inlet 120. The latch 252 is configured to engage with the inlet 120 to fix (latch) the charging connector 25 to the inlet 120. For example, the charging connector 25 is fixed by a tip of the latch 252 being hooked (engaged) in a recess provided in the inlet 120. The latch 252 is linked to the latch release button 251. When the user presses the latch release button 251, the engagement between the recess provided in the inlet 120 and the latch 252 is released (the fixing is released), and the charging connector 25 can be removed from the inlet 120.

The inlet 120 is provided with a lock device 200 (see FIG. 1). The lock device 200 includes an actuator 210 and a lock pin 220. The actuator 210 is controlled by the charging control ECU 101 and the smart ECU 102 to advance and retreat the lock pin 220. The lock device 200 locks the charging connector 25 such that the charging connector 25 cannot be removed from the inlet 120 when the charging connector 25 is mated with the inlet 120. When the charging connector 25 is mated with the inlet 120 and the connector state is in the connected state, the lock pin 220 protrudes from a position indicated by a dashed line, as shown by a dash-dotted line in FIG. 2, and abuts the latch 252. A position where the lock pin 220 abuts the latch 252 is also referred to as a lock position. When the lock pin 220 abuts the latch 252, the latch 252 cannot move in a direction to disengage from the recess provided in the inlet 120. As a result, even when the latch release button 251 is pressed, the engagement between the recess provided in the inlet 120 and the latch 252 cannot be released, and a locked state in which the charging connector 25 cannot be removed from the inlet 120 is achieved.

When the lock pin 220 is returned to the position indicated by the dashed line in FIG. 2 by the actuator 210 of the lock device 200, the user presses the latch release button 251. As a result, the engagement between the recess provided in the inlet 120 and the latch 252 is released, and the charging connector 25 can be removed from the inlet 120. The state is referred to as an unlocked state, and a position of the lock pin 220 in the unlocked state is also referred to as an unlock position. The unlocked state is a state in which the locked state is released.

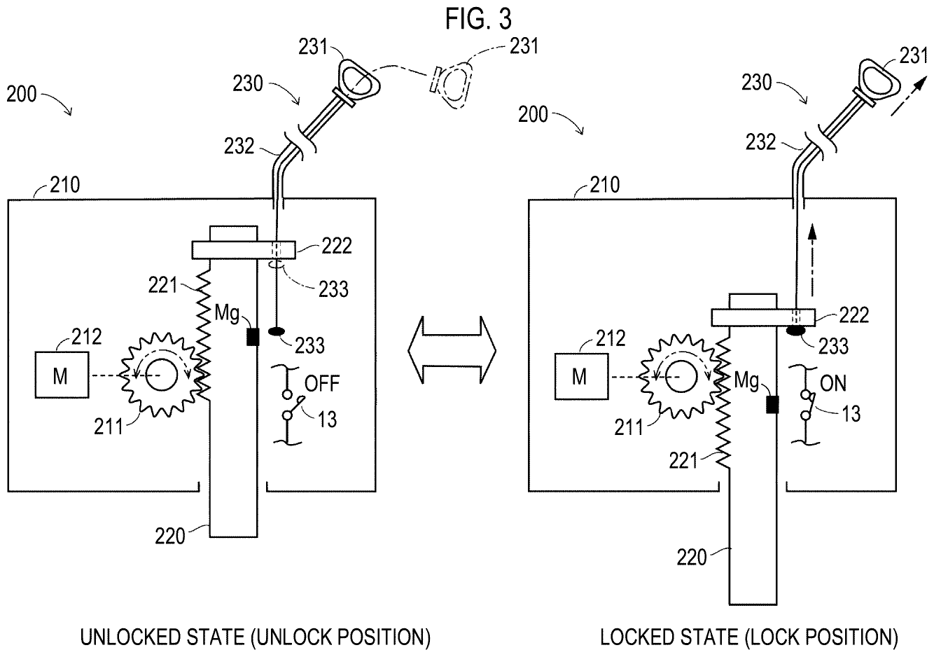

FIG. 3 is a diagram illustrating a schematic configuration of the lock device 200. Inside a housing of the actuator 210 of the lock device 200, a pinion gear 211 driven by a motor 212 and the lock pin 220 provided with a rack gear 221 that meshes with the pinion gear 211 are provided. When the lock device 200 is in the unlocked state (the lock pin 220 is in the unlock position), in a case where the pinion gear 211 is rotationally driven in a clockwise direction by the motor 212, the lock pin 220 advances and retreats to the lock position, and the locked state is achieved. When the lock device 200 is in the locked state (the lock pin 220 is in the lock position), in a case where the pinion gear 211 is rotationally driven in a counterclockwise direction by the motor 212, the lock pin 220 advances and retreats to the unlock position, and the unlocked state is achieved.

The lock device 200 is provided with a position sensor that detects the position of the lock pin 220. In the present embodiment, a limit switch 13 is provided that is OFF when the lock pin 220 is at the unlock position and is ON when the lock pin 220 is at the lock position. The limit switch 13 is a limit switch of a non-contact type, and the lock pin 220 is provided with a magnet Mg at a position facing the limit switch 13 when the lock pin 220 is at the lock position. As a result, when the lock pin 220 is at the lock position, the limit switch 13 is ON, and when the lock pin 220 is at the unlock position, the limit switch 13 is OFF.

A lock release mechanism 230 is provided in the lock device 200. The actuator 210 and the like may have some abnormality. The lock release mechanism 230 is a mechanism that, in an emergency where the lock pin 220 is not switched from the locked state to the unlocked state, is switched from the locked state to the unlocked state by a lock release operation of the user. In the present embodiment, the lock release mechanism 230 includes a release lever 231 and a cable 232. The cable 232 is provided with an inner cable (wire) inside an outer cable (tube). The release lever 231 is fixed to one end of the inner cable, and a cable ferrule 233 is fixed to the other end of the inner cable. The inner cable of the cable 232 penetrates through a through-hole provided in a flange portion 222 of the lock pin 220.

In the emergency where the lock pin 220 is not switched from the locked state to the unlocked state, the user pulls the release lever 231 in the locked state, as indicated by a dash-dotted arrow. When the release lever 231 is pulled, the cable ferrule 233 fixed to the inner cable abuts the flange portion 222, and the lock pin 220 moves to the unlock position as the inner cable moves. As a result, when the user operates the release lever 231, the lock pin 220 moves from the lock position to the unlock position without driving the motor 212 (see the release lever 231 and the cable ferrule 233 in the unlock position by the dash-dotted line).

With reference to FIG. 1, the control device 100 receives information of the battery 10 from a monitoring unit 11. For example, the monitoring unit 11 transmits a temperature TB, a voltage VB, input and output current IB, and the like of the battery 10. The monitoring unit 11 estimates state of charge (SOC) of the battery 10 and transmits the estimated SOC to the control device 100. The control device 100 receives a vehicle speed SPD from a vehicle speed sensor 12 and receives position information (lock position: ON signal, unlock position: OFF signal) of the lock pin 220 from the limit switch 13. The control device 100 outputs a lock command and an unlock command to the actuator 210 to control the lock device 200.

When the user inserts the charging connector 25 into the inlet 120 (charging port 123) while pressing the latch release button 251, the PISW signal is input to the control device 100 (charging control ECU 101) via the terminal PP of the charging connector 25. In addition, the CPLT signal is input to the charging control ECU 101 via the terminal CP. When the charging connector 25 and the inlet 120 are connected, the voltage of the PISW signal is decreased. When the charging control ECU 101 detects the connection between the charging connector 25 and the inlet 120 due to the decrease in the voltage of the PISW signal, the charging control ECU 101 starts the communication with the EVSE 20 for charging preparation by the CPLT signal.

When the charging control ECU 101 detects the connection between the charging connector 25 and the inlet 120 due to the decrease in the voltage of the PISW signal, the charging control ECU 101 outputs the lock command to the actuator 210. When the actuator 210 receives the lock command from the charging control ECU 101, the actuator 210 drives the lock pin 220 to the lock position. Then, when the charging connector 25 and the inlet 120 are in the locked state and the charging preparation of the battery 10 is complete, a request is made to the EVSE 20 to start charging the battery 10, and the charging circuit 130 is controlled.

In the present embodiment, the lock device 200 maintains the locked state until the user performs an unlock operation. The unlock operation by the user is performed by operating an unlock button 125 provided in the inlet 120. When the user presses the unlock button 125, the charging control ECU 101 outputs the unlock command. The actuator 210 drives the lock pin 220 to control the lock pin 220 to the unlock position upon receiving the unlock command.

The lock and unlock of the lock device 200 is also linked to an operation of the smart key 300. As a result, the user can perform the unlock operation using the smart key 300. The smart key 300 is a portable device carried by the user, and communicates with the smart ECU 102 to lock and unlock a door of the vehicle 1. For example, the vehicle 1 (smart ECU 102) transmits a polling signal in a low frequency (LF) band at a predetermined cycle. The smart key 300 that has received the polling signal transmits a response signal in a radio frequency (RF) band. The smart ECU 102 that has received the response signal executes an authentication process. The authentication is established, and the user performs a predetermined operation (for example, a touch operation of a touch sensor provided in a door knob of the vehicle 1). As a result, the smart ECU 102 unlocks the door and outputs the unlock command to the actuator 210. In this case, the unlock command may be transmitted to the actuator 210 via the charging control ECU 101. In addition, the door may be unlocked and the unlock command may be transmitted to the actuator 210 by operating an unlock switch 301 provided in the smart key 300. The actuator 210 drives the lock pin 220 to control the lock pin 220 to the unlock position upon receiving the unlock command.

Even when the user performs the unlock operation using the unlock button 125 or the smart key 300, the locked state may not be switched to the unlocked state. This is considered to be generated due to a failure of the actuator 210, an abnormality of the control device 100 (charging control ECU 101, and the like), and the like. Hereinafter, the failure in which the locked state is not switched to the unlocked state may be also referred to as an unlock failure. When the unlock failure occurs, the user pulls the release lever 231 and operates the lock release mechanism 230 to switch the locked state to the unlocked state in order to remove the charging connector 25 of the inlet 120.

For the convenience of the user or repair, it is preferable to diagnose that the unlock failure occurs. For example, when the position of the lock pin 220 after the unlock command is not the unlock position, the unlock failure can be diagnosed. However, for example, even when the user performs the unlock operation, the unlock command may not be output due to an abnormality and the like of the control device 100. In this case, the unlock command cannot be correlated with the lock pin 220 in association with each other, and the unlock failure cannot be diagnosed. In the present embodiment, the lock release mechanism 230 detects that the locked state is switched to the unlocked state. As a result, the unlock failure can be diagnosed even when the locked state is not switched to the unlocked state due to the fact that the unlock command is not output.

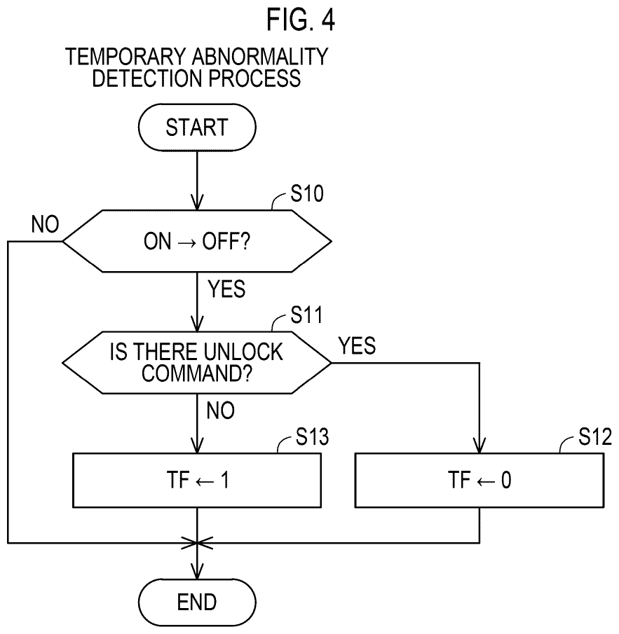

FIG. 4 is a flowchart showing an example of a temporary abnormality detection process executed by the charging control ECU 101. The flowchart is repeatedly executed at predetermined periods during activation of the charging control ECU 101. In step (hereinafter, step is abbreviated as “S”) 10, determination is made as to whether the limit switch 13 is switched from ON to OFF. When the lock pin 220 is at the lock position, the limit switch 13 outputs the ON signal, and when the lock pin 220 is at the unlock position, the limit switch 13 outputs the OFF signal. When the lock device 200 is switched from the locked state to the unlocked state and the limit switch 13 is switched from ON to OFF, the determination is affirmative, and the process proceeds to S11. When the determination is not affirmative, the determination is negative, and the current routine is ended.

In S11, determination is made as to whether the unlock command is output from the charging control ECU 101 and transmitted to the actuator 210 when the limit switch 13 is switched from ON to OFF. When the unlock command is output, the determination is affirmative, and the process proceeds to S12. When the unlock command is not output, the determination is negative, and the process proceeds to S13.

In S12, a flag TF is set to 0, and the current routine is ended. The flag TF is a flag indicating a temporary abnormality of the unlock failure. An initial value of the flag TF may be 0.

In S13, the flag TF is set to 1, and the current routine is ended. For example, the lock release mechanism 230 may be operated and the lock device 200 may be switched from the locked state to the unlocked state. In this case, the position of the lock pin 220 is switched from the lock position to the unlock position without the unlock command being output from the charging control ECU 101. In such a case, the flag TF is set to 1.

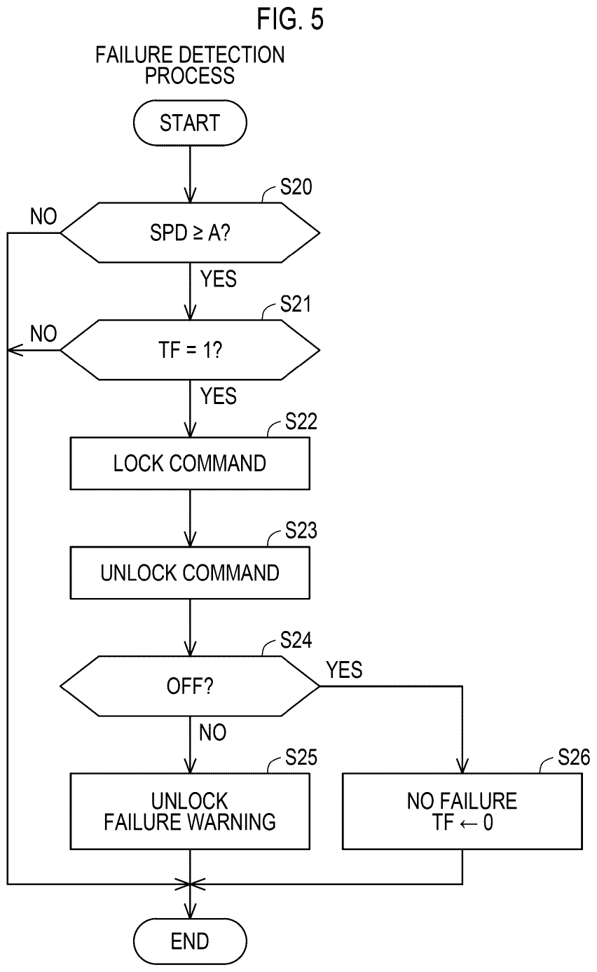

FIG. 5 is a flowchart showing an example of a failure detection process executed by the charging control ECU 101. The flowchart is repeatedly executed at predetermined periods during activation of the charging control ECU 101. In S20, determination is made as to whether the vehicle speed SPD detected by the vehicle speed sensor 12 is equal to or higher than a predetermined value A. The predetermined value A may be a threshold value indicating that the vehicle 1 is traveling, and may be, for example, 5 km/h. When the vehicle speed SPD is less than the predetermined value A, the determination is negative, and the current routine is ended. When the vehicle speed SPD is equal to or higher than the predetermined value A, the determination is affirmative, and the process proceeds to S21.

In S21, determination is made as to whether the flag TF is 1. When the flag TF is 0, the determination is negative, and the current routine is ended. When the flag TF is 1, the determination is affirmative, and the process proceeds to S22.

In S22, the charging control ECU 101 outputs the lock command to the lock device 200 (actuator 210). The actuator 210 that has received the lock command drives the lock pin 220 to the lock position.

In S23 that follows, the charging control ECU 101 outputs the unlock command to the lock device 200. The actuator 210 that has received the unlock command drives the lock pin 220 to the unlock position.

In S24, determination is made as to whether the limit switch 13 is OFF. When the position of the lock pin 220 is the lock position and the limit switch 13 is not OFF (is ON), the determination is negative, and the process proceeds to S25. When the position of the lock pin 220 is the unlock position and the limit switch 13 is OFF, the determination is affirmative, and the process proceeds to S26.

In S25, the unlock failure is diagnosed, the unlock failure is displayed on the HMI device 150, and the current routine is ended.

In S26, no failure is diagnosed, the flag TF is set to 0, and the current routine is ended.

In a failure detection process routine, when the flag TF is 1, the lock pin 220 is driven to the lock position by the lock command (S22), and then the lock pin 220 is driven to the unlock position by the unlock command (S23). When the position of the lock pin 220 is switched from the lock position to the unlock position without the unlock command being output from the charging control ECU 101, for example, when the lock release mechanism 230 is operated, the flag TF is set to 1. In such a state, the actuator 210 drives the lock pin 220 to the lock position, and then drives the lock pin 220 to the unlock position. Then, when the position of the lock pin 220 is the unlock position (affirmative determination in S24), the lock pin 220 is normally driven and can be diagnosed as not having failed. When the position of the lock pin 220 is not the unlock position (negative determination in S24), the unlock failure in which the lock pin 220 can be driven to the lock position, but cannot be driven to the unlock position can be diagnosed.

According to the present embodiment, the actuator 210 of the lock device 200 receives the lock command from the charging control ECU 101 and switches the unlocked state to the locked state. The actuator 210 receives the unlock command from the charging control ECU 101 and switches the lock device from the locked state to the unlocked state. When the lock release mechanism 230 is operated, the locked state is switched to the unlocked state regardless of the operation of the actuator 210. The lock release mechanism 230 may switch the locked state to the unlocked state, and the flag TF may be set to 1. In this case, the charging control ECU 101 outputs the lock command and then outputs the unlock command while the vehicle 1 is traveling (in a state where the charging connector 25 is removed from the inlet 120) (S22, S23). The charging control ECU 101 diagnoses the unlock failure when the lock device 200 is not in the unlocked state (negative determination in S24) after the unlock command (S23) is output.

The unlock operation by the lock release mechanism 230 is highly likely to be performed when the unlock command is not output from the charging control ECU 101 and the unlocked state is not achieved. Alternatively, the probability is high when the actuator 210 fails to operate to the unlocked state and the unlocked state is not achieved. The charging control ECU 101 diagnoses presence or absence of the unlock failure when the charging control ECU 101 detects that the lock release mechanism 230 is operated and the locked state is switched to the unlocked state (the flag TF is set to 1). Therefore, the unlock failure due to the fact that the unlock command is not output from the charging control ECU 101 can also be diagnosed.

In the above-described embodiment, the charging control ECU 101 outputs the lock command to the actuator 210 and controls the actuator 210 to the locked state when the connection between the charging connector 25 and the inlet 120 is detected. However, the lock device 200 may be controlled to the locked state linked to a door lock operation by the smart key 300.

In the above-described embodiment, in S20 of the failure detection process (FIG. 5), the determination is made as to whether the vehicle speed SPD is equal to or higher than the predetermined value A. However, the charging control ECU 101 may proceed to S21 upon detecting that the charging connector 25 is removed from the inlet 120, based on a change in the voltage of the PISW signal.

In the above-described embodiment, the lock device 200 is in the locked state in which the charging connector cannot be removed from the inlet 120 by the lock pin 220 abutting the latch 252. However, the lock mechanism of the lock device may have any configuration. For example, the lock pin of the lock device may be engaged with a recess provided in the charging connector to secure the locked state. In the above-described embodiment, the motor 212 and the rack and pinion mechanism drive the lock pin 220, but the actuator 210 may have any mechanism. For example, a configuration in which the lock pin is driven using an electromagnetic solenoid may be used.

In the above-described embodiment, the cable 232 is used as the lock release mechanism 230. However, the lock release mechanism may have any configuration, and for example, may be configured of a lever or a cam of a leverage type.

The embodiment disclosed is to be considered merely illustrative and not restrictive in all respects. The scope of the disclosure is defined not by the detailed description of embodiments but by the claims, and is intended to cover all equivalents and all modifications within the scope of the claims.

What is claimed is:

1. A vehicle comprising:
an inlet to which a charging connector is connectable;
a lock device configured to switch between a locked state in which the charging connector is not removable from the inlet and an unlocked state in which the charging connector is removable from the inlet; and
a control device, wherein:
the lock device includes an actuator and a lock release mechanism;
the actuator is configured to operate such that the unlocked state is switched to the locked state in response to a lock command from the control device, and the locked state is switched to the unlocked state in response to an unlock command from the control device;
the lock release mechanism is configured to switch the locked state to the unlocked state regardless of the operation of the actuator; and
the control device is configured to,
when detection is made that the lock release mechanism is operated and the locked state is switched to the unlocked state,
output the lock command and then output the unlock command in a state where the charging connector is removed from the inlet, and
diagnose an unlock failure when the lock device is not in the unlocked state after the unlock command is output.

2. The vehicle according to claim 1, wherein:
the lock device includes a lock pin driven by the actuator; and
the control device is configured to detect the locked state and the unlocked state based on a position of the lock pin.

3. The vehicle according to claim 2, wherein the control device is configured to detect that the locked state is switched to the unlocked state by the operation of the lock release mechanism when the position of the lock pin is changed from the locked state to the unlocked state in a state where the unlock command is not output.

4. The vehicle according to claim 1, wherein the control device is configured to diagnose the unlock failure while the vehicle is traveling.

5. The vehicle according to claim 1, wherein the control device is configured to issue an alert when the unlock failure is diagnosed.
